(19) United States
(12) Patent Application Publication
(10) Pub. No.: US 2014/0076049 A1
(43) Pub. Date: Mar. 20, 2014

(54) SYSTEM AND METHOD FOR MONITORING MOVEMENT IN STRATA

(71) Applicants: Stephen Anderson, Mudgee (AU); Andrew Radzievic, Mudgee (AU)

(72) Inventors: Stephen Anderson, Mudgee (AU); Andrew Radzievic, Mudgee (AU)

(21) Appl. No.: 14/111,719

(22) PCT Filed: Apr. 12, 2012
(86) PCT No.: PCT/AU2012/000375

§ 371 Date: Dec. 2, 2013

(30) Foreign Application Priority Data
Apr. 15, 2011 (AU) 2011901462

(51) Int. Cl. G01P 13/00

(52) U.S. Cl. CPC G01P 13/00
USPC 73/488; 29/401.1

(57) ABSTRACT

A system for monitoring movement in strata including at least one sensor embedded in the strata for detecting movement in the strata and for generating first signals indicative of the movement; a storage device in communication with the at least one sensor for collecting and storing the first signals; an analyser in communication with the storage device for analysing the first signals and for triggering an alarm upon a predetermined outcome of the analysis of the first signals.

### FIELD OF THE INVENTION

The present invention relates to strata monitoring devices and specifically to electronic strata monitoring devices. It has been developed specifically to monitor strata in mines and will be described hereinafter with reference to this application. However, it will be appreciated that the invention is not limited to this particular field of use.

### BACKGROUND OF THE INVENTION

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

In an underground mining environment movement of the strata that defines the roof and/or ceiling of a particular tunnel within the mine can result in collapses within the mine. As such there is a need to monitor the movement of the strata to determine the likelihood of movement and the danger of collapse of a portion of strata.

Known systems for measuring strata movement involve installing a plurality of localised sensors in the strata and manually measuring each sensor. The sensor readings are then sent to a central authority for analysis and to determine the likelihood of a collapse. This method is prone to manual error and delays in processing the readings. It is also open to subjective analysis of the readings.

### SUMMARY OF THE INVENTION

Preferred embodiments of the present invention overcome or ameliorate at least one of the disadvantages of the prior art, or to provide a useful alternative.

According to a first aspect of the invention there is provided a system for monitoring movement in strata including:
at least one sensor embedded in the strata for detecting movement in the strata and for generating first signals indicative of the movement;
a storage device in communication with the at least one sensor for collecting and storing the first signals;
an analyser in communication with the storage device for analysing the first signals and for generating an alarm upon a predetermined outcome of the analysis of the first signals.

In some embodiments the analyser generates second signal indicative of a predicted future movement of the strata.

Preferably the at least one sensor generates the first signals at a predetermine time interval. Preferably the at least one sensor generates the first signal in real time. There is no prediction of movement

Preferably the analyser generates the second signal in real time.

Preferably the at least one sensor is in network communication with the storage device. Preferably the network communication is chosen from one or more of the following: Ethernet; wireless; Bluetooth; WIFI; microwave; or the like.

Preferably the analyser is in network communication with the storage device. Preferably the network communication is chosen from one or more of the following: Ethernet; wireless; Bluetooth; WIFI; microwave; or the like.

Preferably a plurality of sensors are embedded in the strata at predetermine points within the strata.

Preferably the analyser includes an alarm that is triggered in the event of a predetermined predicted move of the strata.

Preferably the storage device stores historical data associated with the first signal. Preferably the analyser uses at least a portion the historical data to generate the second signal.

Preferably the storage device stores historical data from other strata and the analyser uses at least a portion of the historical data from other strata to generate the second signal.

Preferably the storage device stores first signals from a plurality of sensors at different locations within the strata. Preferably the storage device stores first signals from a plurality of sensors at different strata.

Preferably the analyser analyses the plurality of first signals and generates plurality of second signals. each second signal indicative of a predicted future movement of relative strata.

According to a second aspect of the invention there is provided a method for monitoring movement in strata, the method including the following steps:
embedding at least one sensor in the strata for detecting movement in the strata and for generating first signals indicative of the movement;
providing a storage device in communication with the at least one sensor for collecting and storing the first signals;
providing an analyser in communication with the storage device for analysing the first signals and for generating an alarm upon a predetermined outcome of the analysis of the first signals.

In some embodiments the method includes the step of generating a second signal indicative of a predicted future movement of the strata.

According to a third embodiment of the invention there is provided a method of converting a mechanical sensor to an electronic sensor, the method including the steps of:
providing a mechanical to electronic conversion sensor, the conversion sensor capable of transforming a mechanical force into an electrical signal; and
retrofitting the conversion sensor onto the mechanical sensor.

Throughout the specification and claims which follow, unless the context requires otherwise, the word “comprise”, and other variations such as “comprises” and “comprising”, will be understood to imply the inclusion of a stated integer or step or group of integers or steps but not the exclusion of any other integer or step or group of integers of steps.

### BRIEF DESCRIPTION OF THE DRAWINGS

A preferred embodiment of the invention will now be described, by way of example only. with reference to the accompanying drawings in which:

FIG. 1 shows a conceptual diagram of a system according to the invention;

FIG. 2 shows a diagram of a conversion of a visual reading sensor to an electronic sensor according to the invention; and

FIG. 3 shows a diagram of a conversion of another visual reading sensor to an electronic sensor according to the invention.

### PREFERRED EMBODIMENT OF THE INVENTION

The preferred embodiment of the invention provides a system for monitoring movement in the stratum or strata of a mine. The strata include the floor and/or ceiling and/or walls or ribs of the mine. The systems includes a plurality of sensor embedded in the strata for detecting movement in the strata and for generating first signals indicative of the movement. A storage device is in network communication with the plurality of sensors for collecting and storing the first signals. An analyser is in network communication with the storage device for analysing the first signals and for generating an alarm in the event that the analysis of the first signals is one of predetermined outcomes. That is, the systems analyses the movement of the strata and will generate an alarm if the movement crosses a threshold value or a predetermined value set by the management of the mine.

In some embodiments the analyser produces a second signal indicative of a predicted future movement of the strata.

In the event that the analyser detects or predicts a significant movement in the strata, such as a collapse or the like, an alarm is triggered and appropriate action can be taken at the mine.

In the event that the analyser detects movement that activates a configured threshold, an alarm is triggered and appropriate action can be taken at the mine.

In the event that the analyser detects a condition that activates a configured alarm, an alarm is triggered and appropriate action can be taken at the mine.

The plurality of sensors generate signals at predetermined intervals every second or minute as required however it is preferred that that the sensors generate signals in real time and that the analyser generate the second signal in real time. Upon the analyser detecting a danger of significant movement or collapse, an alarms is triggered. This ensures that as much time as possible is provided at the mine to take action prior to a collapse or other event. In this way miners, equipment and the like can be moved prior to any actual collapse minimising the loss of life and equipment. In some instances it may be possible to reinforce the particular strata in danger of collapse to prevent such a collapse or weakening.

Any suitable network communication can be used to connect the sensors, the storage device and the analyser with one of the following being preferably Ethernet; wired Ethernet; wireless; Bluetooth; WIFI; microwave; or the like.

In some embodiments the storage server and the analyser are both implement on a single server however in other embodiments they are implemented on separate servers.

The plurality of sensors are embedded in the strata at predetermined strategic points within the strata. The strategic points can be determined by an engineer or other suitably qualified mining personnel.

The storage device stores historical data received from the plurality of sensors and the historical data is used by the analyser to predict the likelihood of future movement of the strata. In some preferred embodiments the storage device stores information from a plurality of strata and from known prior events (including during which strata has collapsed) to provide the analyser with additional data with which to predicts a collapse of the existing strata being monitored.

In some embodiments the storage device receives data from a plurality of sensors each sensor at a different location of the mine and in some embodiments from different mines. In these embodiments the analyser analyses the data from the different locations and different mines. This allows a single monitoring post to monitor movement in many different mines. In other embodiments it may be preferable to have a monitoring station for each mine.

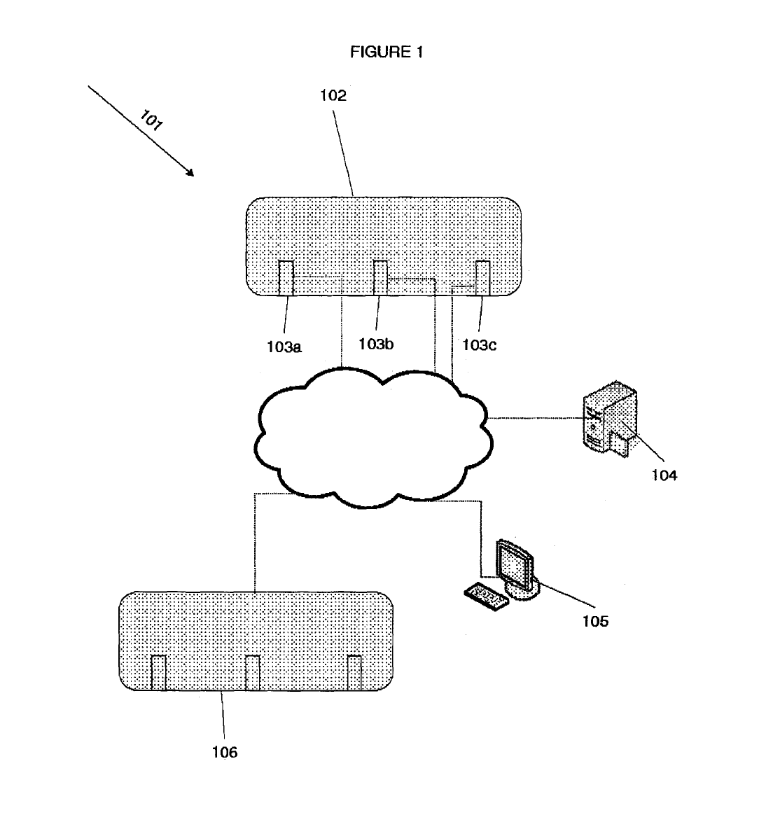

Referring to FIG. 1 there is shown a system 101 for monitoring movement in strata 102. The system includes a plurality of sensors 103(a-c) embedded in the strata for detecting movement in the strata. The sensors are preferably electronic sensors and generate a plurality of first signals indicative of the movement in the strata.

An electronic database 104 is in network communication with the sensors 103. In this embodiment the network communication is by way of wired Ethernet but any suitable network means could be used. In some embodiments wireless communications may be preferred. The database 104 collects and stores the plurality of first signals from each of the sensors. The information is stored such that the data from each sensor can be individually recalled.

An analyser in the form of computer 105 is in network communication with the database 104 for analysing the data stores on the database. The analyser 105 uses known and historical data to predict future movement of the strata and generates a second signal indicative thereof. The second signal can be in the form on an alarm, emails, an electronic signal to another device, sms, audible or visual notification, printout and the like. As would be understood the second signal can be in any form as required and suitable to the application.

As would be understood, the system as described above monitors the movement of the strata in real time and allows mine operators to have up to date real time information which allows them to more efficiently manage situations and take preventative measures where possible and to evacuate staff and equipment as deemed necessary.

As would be understood, the plurality of sensors could be spaced evenly apart in the strata or could be strategically placed according to the requirements of the actual mine. Such placement could be determined by an engineer or suitable qualified mining operator.

In the preferred embodiment, the database stores movement data from other mines and historical data from the current strata and uses all available information to calculate the likelihood of a collapse or other danger.

As would be understood the database 104 and analyser 105 can collect and analyse data from a plurality of strata within the same mine or at different mines such as 106 whether close together or far apart. The communication between mines could be through the Internet or through dedicated communications channels.

In some environments, mechanical movement sensors may already be fitted in some locations. These mechanical sensors must be read manually. In these embodiments it is advantageous to retrofit the sensors to convert them into electrical sensors. The conversion kits includes a mechanical to electronic conversion sensor, the conversion sensor capable of transforming a mechanical force into an electrical signal. As would be understood the conversion sensor is retrofitted to the mechanical sensor to convert the output into an electrical output. The sensor can then be connected to the system of the preferred embodiment. In some embodiments new electrical sensors are installed in the strata as described above.

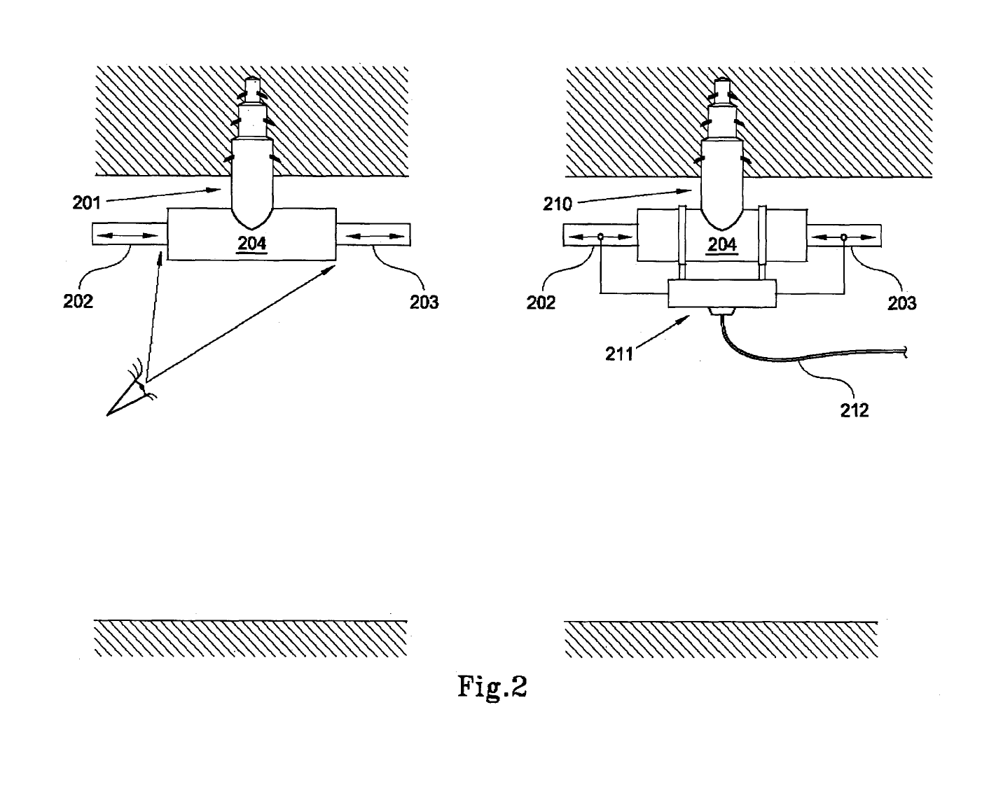

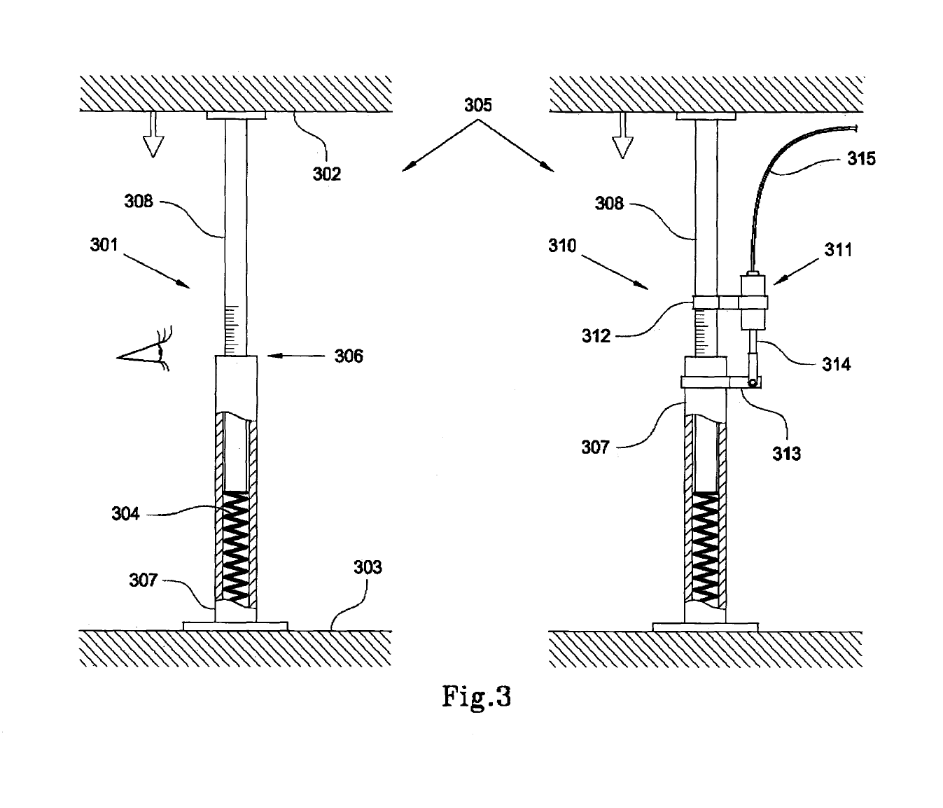

Suitable retrofitting configurations are shown in FIGS. 2 and 3. Referring to FIG. 2, sensor 201 is a mechanical movement sensor which must be read visually. Movement in the strata causes the arms 202 and 203 to retract or extend from the body 204 of the sensor. The movement is then read visually.

Sensor 210 is shown as a retrofitted sensor where retrofit device 211 is fitted to the body 204 of the device. The retrofit device connects to each arm 202 and 203 and converts the mechanical movement into an electrical signal. The signal is then connected to the monitoring system as described above by electrical communications cable 212.

Referring to FIG. 3, there is shown a sensor 301 adapted to be installed between the ceiling 302 and floor 303 of a mine shaft 305. The sensor includes a spring system 304 to allow for movement in the shaft 305. Portion 307 of the sensor is fixed in length and moveable portion 308 moves in and/or out of the fixed portion by means of the spring system 304 as the shaft moves. A gauge 306 is visually read to monitor movement in the shaft.

Sensor 310 is shown as a retrofitted sensor 301 where retrofit device 302 is fixedly connected on one end 312 to the moveable portion 308 by connector 312 and on the other end to the fixed portion 307 by connector 313. Displacement sensor 314 provides an electronic measurement as the mine shaft moves which is connected through electrical communications cable 311 to the monitoring system as described above.

Embodiments of the present invention provide the following additional advantages:
Monitoring of Displacement, rate of movement & acceleration.
Alarm triggers can be any mathematical calculation on data from any point in recorded history.
Exported data unit type selectable (rate, acceleration etc).
Exported data interval selectable
Designed for devices up to 5 channels.
Automatic detection of sensor being reset due to maximum travel—displacement continues to accumulate & read correctly.
Detection of invalid movement (for example bumped by machinery) and ability to alarm of this event.
Alarm scripting allows users to define advanced triggers for alarms, for example rate of movement can be over the time of 1 minute to selected time frame. Values include Raw, Displacement, Rate of movement & Acceleration
Alarms configurable to four priorities (Information, Advisory, Warning and Critical).
Graphs selectable in Raw, Displacement, Rate (min/hour/day/week) & Acceleration (min/hour/day/week).
Alarms configurable can include/exclude all sensors and channels down to a single channel.
Backfills missing history information (fills missing data with data ramped between last two good data points)
Export data in Raw, Displacement, Movement/Minute, Movement/Hour, Movement/Day, Movement/Week, Acceleration/Minute, Acceleration/Hour, Acceleration/Day & Acceleration/Week.
Perform following functions on historical data—Set offset, Set displacement, Ramp offset, Ramp displacement, Add(subtract) offset, Add(subtract) displacement.
Software designed for 5 channel devices, no workarounds required such as assigning two 2 channel points to monitor a 4 channel device.
Multiple triggers can be configured for each point/channel.
Channels within software can be disabled to correctly monitor and alarm devices with less than 5 channels.

In the preferred embodiment, the face distance is used as part of the calculation to generate an alarm. The face distance is the front or end of a drift, tunnel or excavation, where the material is being or was last mined. That is, the distance measured between the face and each respective sensor is used at least as a portion of the computation on whether or not to trigger an alarm. The distance between the sensor and the face can be entered manually by a user of the system or calculated automatically using. for example, the length of the conveyor with a Formula such as:

EncoderCircumference/EncoderNumOfTargets*PulseCountsFromEncoder.

In the preferred embodiment the installed support level at the point at which the sensor is installed is taken into account when determining whether or not to trigger an alarm. When a sensor is configuration in software, the software allows the user to select “installed support” at place of sensor installation. As would be understood, the support level is the level of physical support structures installed at the point in the mine at which the sensor is installed. The support is configured with a “strength” value within the software to allow comparisons by the analyser. It is possible for alarms to be configured as follows for example:

If movement>xx and supportlevel>xx then raise alarm.

Another example would be:

If supportlevel=0 (no support) and faceposition<100 M then raise an alarm.

There are hundreds of available computer languages that may be used to implement embodiments of the invention, among the more common being Ada; Algol; APL; awk; Basic; C; C++; Cobol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; and XML.

Any commercial processor may be used to implement the embodiments of the invention either as a single processor, serial or parallel set of processors in the system. Examples of commercial processors include, but are not limited to Merced™, Pentium™, Pentium II™, Xeon™, Celeron™, Pentium Pro™, Efficeon™, Athlon, AMD and the like.

Display screens may be segment display screen, analogue display screens, digital display screens, CRTs, LED screens, Plasma screens, liquid crystal diode screens, and the like.

Although the invention has been described with reference to specific examples, it will be appreciated by those skilled in the art that the invention may be embodied in many other forms.

1. A system for monitoring movement in strata comprising:
at least one sensor embedded in the strata for detecting movement in the strata and for generating first signals indicative of the movement;
a storage device in communication with the at least one sensor for collecting and storing the first signals;
an analyser in communication with the storage device for analysing the first signals an analyser in communication with the storage device for analysing the first signals and for triggering an alarm upon a predetermined outcome of the analysis of the first signals.

2. A system according to claim 1 wherein the analyser generates a second signal indicative of a predicted future movement of the strata.

3. A system according to claim 1 wherein the sensor generates the first signals at a predetermine time interval.

4. A system according to claim 2 wherein the at least one sensor generates the first signal in real time.

5. A system according to claim 3 wherein the analyser generates the second signal in real time.

6. A system according to claim 4 wherein the at least one sensor is in network communication with the storage device.

7. A system according to claim 5 wherein the plurality of sensors are embedded in the strata at predetermine points within the strata.

8. A system according to claim 6 wherein the analyser includes an alarm that is triggered in the event of a predetermined predicted move of the strata.

9. A system according to claim 7 wherein the storage device stores historical data associated with the first signal.

10. A system according to claim 8 wherein the analyser uses at least a portion the historical data to generate the second signal.

11. A system according to claim 9 wherein the storage device stores historical data from other strata and the analyser uses at least a portion of the historical data from other strata to generate the second signal.

12. A system according to claim 10 wherein the storage device stores first signals from a plurality of sensors at different locations within the strata.

13. A system according to claim 12 wherein the analyser analyses the plurality of first signals and generates plurality of second signals, each second signal indicative of a predicted future movement of relative strata.

14. A system according to claim 1 wherein the triggering of the alarm is dependent at least in part on the face distance being the distance between the mine face and the sensor.

15. A system according to claim 1 wherein the triggering of the alarm is dependent at least in part on the installed support at the sensor.

16. A system according to claim 1 wherein the sensor is reset due to maximum travel and wherein displacement continues to accumulate and read correctly

17. A method for monitoring movement in strata, the method comprising the following steps:
embedding at least one sensor in the strata for detecting movement in the strata and for generating first signals indicative of the movement;
providing a storage device in communication with the at least one sensor for collecting and storing the first signals; and
providing an analyser in communication with the storage device for analysing the first signals and for generating an alarm upon a predetermined outcome of the analysis of the first signals.

18. A method of converting a mechanical sensor to an electronic sensor, the method comprising the steps of:
providing a mechanical to electronic conversion sensor, the conversion sensor capable of transforming a mechanical force into an electrical signal; and
retrofitting the conversion sensor onto the mechanical sensor.

19. A method as recited in claim 17, wherein the analyser generates a second signal indicative of a predicted future movement of the strata.

20. A method as recited in claim 17 wherein the triggering of the alarm is dependent at least in part on a face distance determined as being the distance between the mine face and the sensor.
